(19) United States
(12) Patent Application Publication
(10) Pub. No.: US 2009/0157959 A1
(43) Pub. Date: Jun. 18, 2009

(54) STORAGE MEDIUM CONTROL DEVICE, STORAGE MEDIUM MANAGING SYSTEM, STORAGE MEDIUM CONTROL METHOD, AND STORAGE MEDIUM CONTROL PROGRAM

(76) Inventor: Manabu MIYAZAKI, Tokyo (JP)

Correspondence Address: NEC CORPORATION OF AMERICA, 6535 N. STATE HWY 161, IRVING, TX, 75039, US

(21) Appl. No.: 12/332,692

(22) Filed: Dec. 11, 2008

(30) Foreign Application Priority Data
Dec. 18, 2007 (JP) 2007-326580

(51) Int. Cl. G06F 12/08

(52) U.S. Cl. 711/114; 711/E12.019

(57) ABSTRACT

To provide a storage medium control device capable of preventing decrease in the reliability of data saving with a non-redundant structure. Provided is a storage medium control device capable of communicating with a higher-order device, for managing/controlling an information storage device main body configured with physical storage media to be capable of storing information with a non-redundant structure. The device includes: a region allotment processing device for allotting each physical recording medium to a user useable region and to a substitute sector region, respectively; a fault sector detecting device for checking sectors of the user useable region allotted by the region allotment processing device in initialization processing of the non-redundant structure to detect a fault sector from which information cannot be read out; and a fault sector exchange processing device for exchanging the detected fault sector of the user useable region with a normal sector of the substitute sector region.

### CROSS-REFERENCE TO RELATED APPLICATION

This application is based upon and claims the benefit of priority from Japanese patent application No. 2007-326580, filed on Dec. 18, 2007, the disclosure of which is incorporated herein in its entirety by reference.

### BACKGROUND OF THE INVENTION

1. Field of the Invention

The present invention relates to a storage medium control device, an information storage device, a storage medium managing system, a storage medium control method, a storage medium control program, and the like. More specifically, the present invention relates to a disk array device.

2. Description of the Related Art

In the field of computer systems, there is a technique called RAID (Redundant Array of Independent Disks) as a technique for improving the reliability and the access speed for storage media such as HDDs (Hard Disk Drives).

With RAID, a plurality of HDDs are used to configure a disk array device (information storage device). The disk array device is known as a system which can provide higher reliability than a single hard disk device, and it is classified into a plurality of different specifications such as RAID 0, RAID 1, - - - , RAID 5.

With RAID, high-speed, high-reliability, and anti-failure properties can be secured by taking various measures such as striping (non-redundant structure) which divides data and reads/writes data in parallel from/to a plurality of HDDs when reading/writing the data, and mirroring which gives a redundant structure to the data.

First, RAID 0 is a specification where data striping is performed for a plurality of hard disk devices. The “striping” herein means to divide a single data block into a plurality of logic blocks and store those to a plurality of hard disk devices. RAID 1 is a specification which duplicates the hard disk device (mirroring). RAID 2 and RAID 3 are specifications which divide data by a bit unit and store those to individual hard disk devices. RAID 4 and RAID 5 are specifications which can operate each of the hard disk devices independently and perform parallel processing of readout/writing instructions.

Particularly, RAID 0 is a non-redundant structure, and it is designed to increase the speed by distributing data equally to a plurality of storage media and performing simultaneous and parallel reading/writing processing. As a structural example of RAID 0 of such disk array device, there is a technique disclosed in Japanese Unexamined Patent Publication 2007-79968 (Patent Document 1), for example.

Patent Document 1 discloses a technique regarding a device which configures RAID 0 that builds a logically single storage region by distributing and storing data to a detachable storage device and to a built-in storage device.

However, there are following shortcomings with the disk array device that is configured with RAID 0 as in Patent Document 1.

Under an environment with a redundant structure (RAID 5, for example), it is possible to recover from a failure by restoring correct data through the use of the redundant structure when a failure sector is found. However, RAID 0 is not a redundant structure, so that the entire data is lost when there is a single failure sector generated in the storage medium. Therefore, it is not possible to perform recovering processing easily, which results in deteriorating the reliability in data saving.

For example, during an operation, when there is a failure sector in a region that is being used, a partial recovery is not possible. Thus, it is required to rebuild the RAID structure. When there is a failure sector generated while it is in use after initialization processing of HDDs performed at the time of building the initial RAID structure, the initialization processing of the HDDs at the time of building the RAID structure needs to be performed again. Thus, the data becomes unusable, so that the reliability in terms of saving the data is extremely deteriorated.

### SUMMARY OF THE INVENTION

The present invention has been designed to overcome such technical shortcomings, and it is an exemplary object of the present invention to provide a storage medium control device and the like with a non-redundant structure, which can prevent deterioration in the reliability in terms of saving data.

In order to achieve the foregoing exemplary object, the storage medium control device according to an exemplary aspect of the invention is a storage medium control device that is capable of communicating with a higher-order device and capable of managing/controlling an information storage device main body which is configured with a plurality of physical storage media to be able to store information with a non-redundant structure. The storage medium control device includes: a region allotment processing device which performs processing for allotting each of the physical recording media to a user useable region and to a substitute sector region, respectively; a fault sector detecting device which performs processing for checking sectors of the user useable region allotted by the region allotment processing device in initialization processing of the non-redundant structure to detect presence of a fault sector from which information cannot be read out; and a fault sector exchange processing device which performs processing for exchanging the fault sector of the user useable region detected by the fault sector detecting device in the initialization processing with a normal sector of the substitute sector region of the physical storage media.

The storage medium managing system device according to another exemplary aspect of the invention includes: an information storage medium device main body which is configured with a plurality of physical storage media to be capable of storing information with a non-redundant structure; a storage medium control device for managing/controlling the information storage device main body; and a higher-order device that is communicable with the storage medium control device. The storage medium control device includes: a region allotment processing device which performs processing for allotting each of the physical recording media to a user useable region and to a substitute sector region, respectively; a fault sector detecting device which performs processing for checking sectors of the user useable region allotted by the region allotment processing device in initialization processing of the non-redundant structure to detect presence of a fault sector from which information cannot be read out; and a fault sector exchange processing device which performs processing for exchanging the fault sector of the user useable region detected by the fault sector detecting device in the initialization processing with a normal sector of the substitute sector region of the physical storage media.

The storage medium control method according to still another exemplary aspect of the invention is a method for managing/controlling an information storage device main body which is communicable with a higher-order device and is configured with a plurality of physical storage media to be capable of storing information with a non-redundant structure. The method includes: a region allotment processing step which performs processing for allotting each of the physical storage media to a user useable region and to a substitute sector region, respectively; a fault sector detecting step which executes processing for checking presence of a fault sector from which data cannot be read out by checking the sectors of the user useable region that is allotted by the region allotment processing step at a time of initialization of the non-redundant structure; and a fault sector exchange processing step which performs processing for exchanging the fault sector of the user useable region that is detected by the fault sector detecting step at the time of initialization with a normal sector of the substitute sector region of the physical storage media.

The storage medium control program according to still another exemplary aspect of the invention is a program for allowing a computer, which is provided to a storage medium control device capable of communicating with a higher-order device and capable of managing/controlling an information storage device main body that is configured with a plurality of physical storage media to be able to store information with a non-redundant structure, to execute: a region allotment processing function which performs processing for allotting each of the physical recording media to a user useable region and to a substitute sector region, respectively; a fault sector detecting function which performs processing for checking sectors of the user useable region allotted by the region allotment processing function in initialization processing of the non-redundant structure to detect presence of a fault sector from which information cannot be read out; and a fault sector exchange processing function which performs processing for exchanging the fault sector of the user useable region detected by the fault sector detecting function in the initialization processing with a normal sector of the substitute sector region of the physical storage media.

### BRIEF DESCRIPTION OF THE DRAWINGS

FIG. 1 is a block diagram showing an example of an overall structure of a storage medium control system including a storage medium control device according to a first exemplary embodiment of the invention;

FIG. 2 is a block diagram showing an example of detailed functional structures of each part of a controller that is shown in FIG. 1;

FIG. 3 is a block diagram showing an example of detailed functional structures of each part of the controller that is shown in FIG. 1;

FIG. 4 is a block diagram showing an example of detailed functional structures of each part of a host computer that is shown in FIG. 1;

FIG. 5 is a flowchart showing an example of a processing order of the storage medium control system including the storage medium control device according to the first exemplary embodiment of the invention;

FIG. 6 is a flowchart showing an example of a processing order of the storage medium control system including the storage medium control device according to the first exemplary embodiment of the invention;

FIG. 7 is a flowchart showing an example of a processing order of the storage medium control system including the storage medium control device according to the first exemplary embodiment of the invention; and

FIG. 8 is a block diagram showing an example of an overall structure of a storage medium control system including a storage medium control device according to a second exemplary embodiment of the invention.

### DETAILED DESCRIPTION OF THE EXEMPLARY EMBODIMENTS

### Basic Structures of Exemplary Embodiments of the Invention

First, basic structures of a storage medium control device according to exemplary embodiments of the invention will be described.

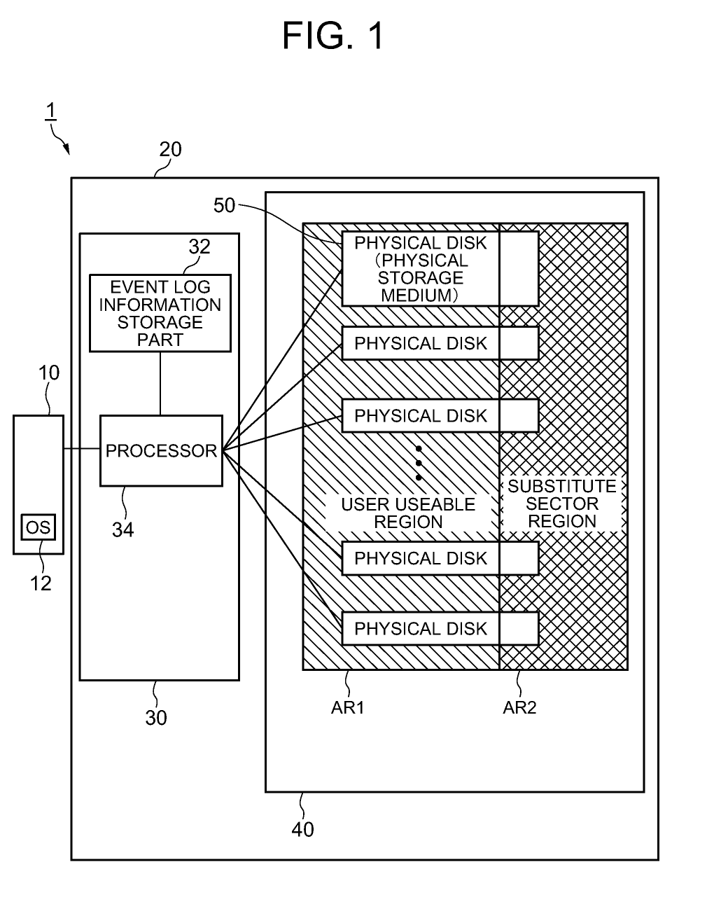

The storage medium control device (the one shown with reference numeral 30 in FIG. 1, for example) according to the exemplary embodiments of the invention is capable of communicating with a higher-order device (the one shown with reference numeral 10 in FIG. 1, for example) and capable of managing/controlling an information storage device main body (the one shown with reference numeral 40 in FIG. 1, for example) which is configured with a plurality of physical storage media to be able to store information with a non-redundant structure.

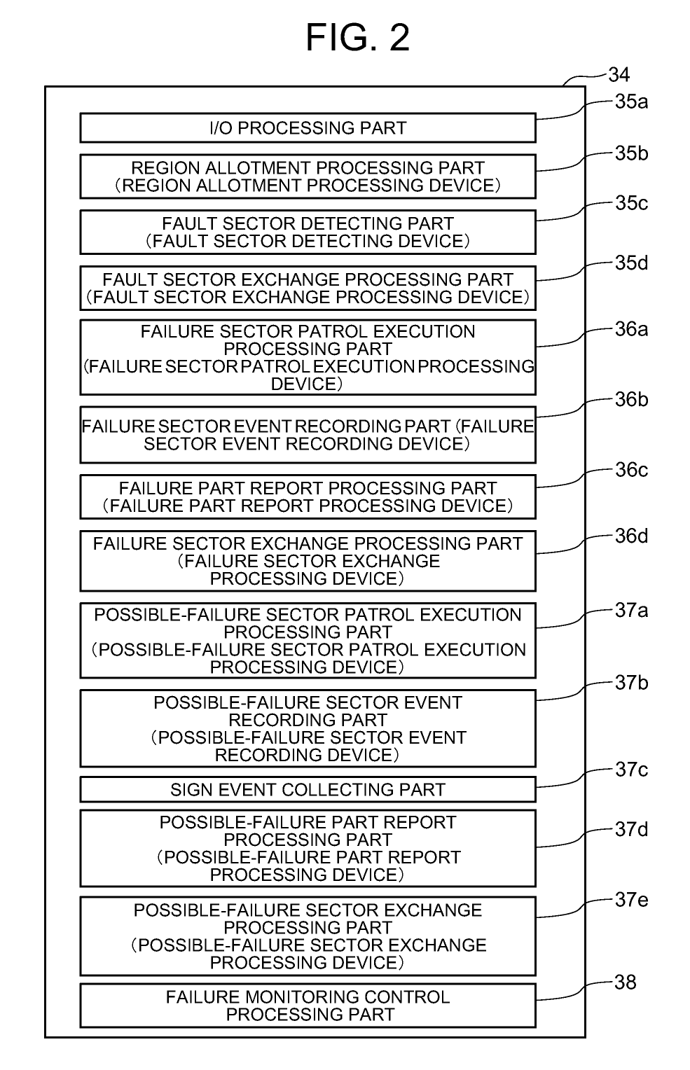

This storage medium control device is structured to include: an initialization control processing device (the one shown with reference numeral 35b in FIG. 2, for example) which performs initialization control processing for allotting each of the physical storage media to a user useable region and to a substitute sector region; a failure sector patrol execution processing device (the one shown with reference numeral 36a in FIG. 2, for example) which executes patrol processing for checking presence of a failure sector of the physical storage media for the user useable region that is used when operating the plurality of physical storage media initialized by the initialization control processing device; and a failure sector exchange processing device (the one shown with reference numeral 36d in FIG. 2, for example) which performs processing for exchanging the failure sector of the user useable region that is detected as a result of the patrol executed by the failure sector patrol execution processing device with a normal sector of the substitute sector region of the physical storage medium.

The storage medium control device structured in the manner described above works as follows. That is: a region allotment processing device forms the user useable region and the substitute sector region at a stage of performing the initialization processing for forming the non-redundant information storage device; a fault sector detecting device checks sectors of the user useable region to detect presence of a fault sector from which information cannot be read out; and a fault sector exchange processing device performs processing for exchanging the fault sector of the user useable region detected by the fault sector exchange processing device with a normal sector of the substitute sector region. Therefore, the sector that is known to be broken before being used by the user can be eliminated in advance, so that it is possible to improve the reliability in terms of saving data.

Further, the storage medium control device can also have: a failure sector patrol execution processing device (the one shown with reference numeral 36a in FIG. 2, for example) which executes patrol processing for checking presence of a failure sector of the physical storage media for the user useable region that is used when operating the plurality of physical storage media initialized by the initialization control processing device; and a failure sector exchange processing device (the one shown with reference numeral 36d in FIG. 2, for example) which performs processing for exchanging the failure sector of the user useable region that is detected as a result of the patrol executed by the failure sector patrol execution processing device with a normal sector of the substitute sector region of the physical storage medium.

With the storage medium control device structured in the manner described above, it is possible to conduct a patrol during the operation to check whether or not there is a failure sector. When a failure sector is found in the patrol, it can be exchanged with a substitute sector so as to execute recovering promptly.

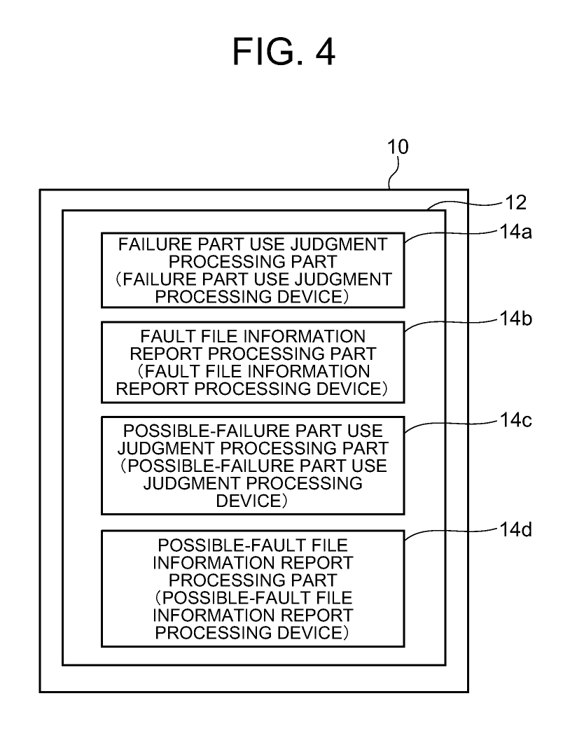

Further, a higher-order device according to the exemplary embodiments of the invention is capable of communicating with the storage medium control device that manages/controls the information storage device main body which is configured with a plurality of physical storage media to be capable of storing information with a non-redundant structure. The higher-order device is structured to include: a failure part use judgment processing device (the one shown with reference numeral 14a in FIG. 4, for example) which performs processing for patrolling presence of a failure sector of the user useable region out of the user useable region and the substitute sector region respectively allotted to each of the physical storage media by the storage medium control device, and judging whether or not the failure part of the failure sector reported by the storage medium control device is being used; and a fault file report processing device (the one shown with reference numeral 14b in FIG. 4, for example) which, when the failure part is judged by the failure part use judgment processing device as being used, performs processing for reporting the user that the file corresponding to the failure sector is a fault file (broken file).

With the higher-order device structured in the manner described above, the failure part can be reported to the user when the failure sector is being used. This enables the user to take a countermeasure for the failure in a flexible manner.

Hereinafter, an example of preferred exemplary embodiments of the storage medium managing system including the storage medium control device and the higher-order device according to the exemplary embodiments of the invention will be described in a concretive manner by referring to the accompanying drawings.

### First Exemplary Embodiment

### (Overall Structure of Storage Medium Managing System)

As the specific structure of the storage medium managing system according to this exemplary embodiment, the overall structure will be described first, and detailed structure of each part will be described thereafter. FIG. 1 is a block diagram showing an example of an overall schematic structure of the storage medium managing system including the storage medium control device according to the first exemplary embodiment of the invention.

As shown in FIG. 1, a storage medium managing system 1 is structured, including: a host computer 10 as an example of the higher-order device; and a disk array device 20 formed to be capable of communicating with the host computer 10 via a network, which is a form of an information storage device for storing information from the host computer 10 to the physical storage medium.

An example of the network may be a Fibre Channel network.

The host computer 10 transmits a read command (request), a write command (request), and the like to the disk array device 20.

The disk array device 20 receives the read command and the write command from the host computer 10, and reads and writes information from/to a RAID structure.

The disk array device 20 is structured, including: a physical disk group (the information storage device main body) 40 having a RAID structure where a plurality of physical disks 50 such as HDDs as an example of the physical storage medium are provided; and a controller 30 (RAID controller) for giving/receiving information such as reading/writing information from/to each of the physical disks 50 of the physical disk group 40 and performing various kinds of controls.

The controller (RAID controller) 30 is a RAID control device (storage medium control device) used in the disk array device 20, which controls the physical disk group 40 as the RAID structure.

The controller 30 is structured, including: a processor 34 for managing the controls of each part; and an event log information storage part 32 for storing information regarding various kinds of events such as information regarding the failure sector as a log.

Other than those, the controller 30 can also include a memory for storing various kinds of information required for performing control processing.

With this exemplary embodiment, the controller 30 can execute a control for each of the physical disks 50 of the physical disk group 40 to store the information with the non-redundant structure (RAID 0, for example). Thus, it is supposed that the disk array device has a “RAID 0” function (non-redundant structure).

The RAID structure by the RAID 0 is configured by using the physical disk group 40 that is a set of the physical disks 50 provided to the disk array device 20.

Further, for managing the regions, the physical disk group 40 is separated into a user useable region AR1 that can be used by the user and a substitute sector region AR2. Specifically, a single physical disk 50 is sectioned into a user useable region and a substitute sector region. A set of the user useable regions of each of the physical disks 50 is formed as the user useable region AR1. Further, a set of the substitute sector regions of each of the physical disks 50 is formed as the substitute sector region AR2.

Among the disk capacitance, a part thereof is allotted to the substitute sector region AR2, and the other remaining part (most of the part) is allotted to the user useable region A1. The disk capacity from an OS operated in the host computer 10 is the size of the user useable region AR1.

Further, the disk array device 20 can have a host interface, a cache memory, and the like, in addition to having the controller (RAID controller) 30. The host interface receives read command, a write command, and the like from the host computer 10. The cache memory caches the information received from the host computer 10 or the information transmitted to the host computer 10.

In this case, when there is a read command from the host computer 10 and the requested information is in the cache memory, the host interface transmits the information to the host computer 10. In the meantime, when the information is not in the cache memory, the host interface requests the controller 30 to read the information from the physical disk group 40, and transmits the request information obtained via the controller 30 to the host computer 10.

Further, upon receiving a write command from the host computer 10, the host interface writes request information to the cache memory, and returns a response to the host computer 10. After the information is written to the cache memory, the controller 30 starts writing processing to the physical disk group 40.

### (Detailed Functional Structure of Controller)

Next, detailed functions of the processor provided to the controller will be described by referring to FIG. 2. FIG. 2 is a block diagram showing an example of the detailed functional structures of each part of the controller shown in FIG. 1.

As shown in FIG. 2, the processor 34 is structured, including: an I/O processing part 35a for performing normal I/O processing; a region allotment processing part 35b for performing processing for allotting each of the physical disks 50 to the user useable region AR1 and the substitute sector region AR2, respectively; a fault sector detecting part 35c which performs processing for checking sectors of the user useable region AR1 allotted by the region allotment processing part 35b in the initialization processing of the non-redundant structure to detect presence of a fault sector from which information cannot be read out; and a fault sector exchange processing part 35d which performs processing for exchanging the fault sector of the user useable region AR1 detected by the fault sector detecting part 35c in the initialization processing with a normal sector of the substitute sector region AR2 of the physical disk 50.

Further, the processor 34 is structured, including a failure sector patrol execution processing part 36a which executes patrol processing for checking presence of a failure sector of the physical disks 50 for the user useable region AR1 that is used when operating the plurality of initialized physical disks 50.

Furthermore, the processor 34 is structured, including: a failure sector event recording part 36b which performs processing for recording an event log of the failure part of the failure sector to a specific storage region of the event log information storage part 32; a failure part report processing part 36c which performs processing for reporting the failure part of the failure sector to the host computer 10; and a failure sector exchange processing device 36d which performs processing for exchanging the failure sector of the user useable region AR1 that is detected as a result of the patrol executed by the failure sector patrol execution processing device 36a with a normal sector of the substitute sector region AR2 of the physical disk 50.

Moreover, the processor 34 is structured, including: a possible-failure sector patrol execution processing part 37a which conducts a patrol for checking presence of a possible-failure sector of the physical disk 50 showing a sign of having a failure; a possible-failure sector event recording part 37b which performs processing for recording an event log of the possible-failure part of the possible-failure sector to a specific storage region; a sign event collecting part 37c which collects an possible-failure event from carious kinds of event log information in the event log information storage part 32; a possible-failure part report processing part 37d which performs processing for reporting the possible-failure part of the possible-failure sector to the host computer 10; a possible-failure sector exchange processing part 37e which performs processing for exchanging the possible-failure sector that is detected as a result of the patrol executed by the possible-failure sector patrol execution processing part 37a with a normal sector of the substitute sector region of the physical disk 50; and a failure monitoring control processing part 38 which performs controls to operate each of those parts according to the execution procedures as required.

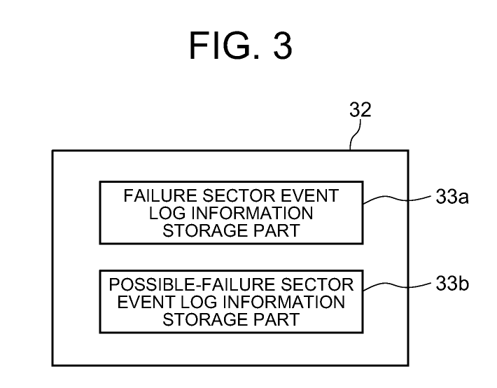

As shown in FIG. 3, the event log information storage part 32 is structured, including: a failure sector event log information storage part 33a which stores the event log information regarding the failure sector; and a possible-failure sector event log information storage part 33b which stores the event log information regarding the possible-failure sector.

As described above, when a failure sector is found during a patrol, the processor 34 can report the failure part to an OS 12 operated in the host computer 10 and exchange the failure sector with a normal sector of the substitute sector region AR2. Further, not only the failure event, the processor 34 can also collect the possible-failure event and exchange it with the substitute sector.

### (Detailed Structure of Host Computer)

Next, detailed functions of the host computer will be described by referring to FIG. 4. FIG. 4 is a block diagram showing an example of detailed functional structures of each part of the host computer.

As the hardware structures, the host computer 10 has: a display device (screen) for displaying various information and the like; an operation input device (a keyboard, a mouse, and the like, for example) for operating/inputting data on the display screen (various input sections and the like) of the display device; a transmitting/receiving device (communication device) for transmitting/receiving various kinds of signals and data; a storage device (memory, hard disk, or the like, for example) for storing various kinds of programs and various kinds of data; and a control device (CPU or the like, for example) for administering controls of those devices.

Further, other than the hardware structures, the host computer 10 includes the OS 12 as a software structure.

As shown in FIG. 4, the functional structure of the OS 12 includes: a failure part use judgment processing part 14a which patrols presence of a failure sector of the user useable region out of the user useable region and the substitute sector region respectively allotted to each of the physical storage media by the storage medium control device, and judges whether or not the failure part of the failure sector reported by the storage medium control device is being used; and a fault file report processing part 14b which, when the failure part is judged by the failure part use judgment processing part 14a as being used, performs processing for reporting the user that the file corresponding to the failure sector is a broken fault file.

Further, the functional structure of the OS 12 includes: a possible-failure part use judgment processing part 14c which performs processing for judging whether or not the possible-failure part of the possible-failure sector reported from the storage medium control device showing a sign of having a failure is being used; and a possible-fault file report processing part 14d which, when the possible-failure part is judged by the possible-failure part use judgment processing part 14c as being used, performs processing for reporting the user that the file corresponding to the possible-failure sector is a possible-fault file that has a possibility of being broken.

As described, with the OS 12 operated in the host computer 10, it is possible to judge whether or not the reported failure part is being used by searching a table of a file system.

Note here that the host computer 10 is operated by controls of programs. As long as it has a network-related function, there is no limit set in regards to its type such as a movable type or a fixed type, i.e., may be a desktop computer, a laptop computer, an information device having radio/wired communicating function, or a computer similar to those.

The region allotment processing part 35b of this exemplary embodiment can configure the “region allotment processing device”. Further, the fault sector detecting part 35c of this exemplary embodiment can configure the “fault sector detecting device”. Furthermore, the fault sector exchange processing part 35d of this exemplary embodiment can configure the “fault sector exchange processing device”.

Further, the failure sector patrol execution processing part 36a of this exemplary embodiment can configure the “failure sector patrol execution processing device”. Furthermore, the failure sector event recording part 36b of this exemplary embodiment can configure the “failure sector event recording device”. Moreover, the failure part report processing part 36c of this exemplary embodiment can configure the “failure part report processing device”. Further, the failure sector exchange processing part 36d of this exemplary embodiment can configure the “failure sector exchange processing device”.

Furthermore, the possible-failure sector patrol execution processing part 37a of this exemplary embodiment can configure the “possible-failure sector patrol execution processing device”. Moreover, the possible-failure sector event recording part 37b of this exemplary embodiment can configure the “possible-failure sector event recording device”. Further, the possible-failure part report processing part 37d of this exemplary embodiment can configure the possible-failure part report processing device”. Furthermore, the possible-failure sector exchange processing part 37e of this exemplary embodiment can configure the “possible-failure sector exchange processing device”.

Moreover, the failure part use judgment processing part 14a of this exemplary embodiment can configure the “failure part use judgment processing device”. Further, the fault file report processing part 14b of this exemplary embodiment can configure the “fault file report processing device”. Furthermore, the possible-failure part use judgment processing part 14c of this exemplary embodiment can configure the possible-failure part use judgment processing device”. Moreover, the possible-fault file report processing part 14d of this exemplary embodiment can configure the “possible-fault file report processing device”.

### (Outline of Storage Medium Managing System Operations)

The storage medium managing system 1 structured as described above roughly operates as follows.

First, at the time of building RAID 0, the whole physical disk group 20 is allotted to the user useable region AR1 that can be used by the user from the OS and to the substitute sector region AR2 that is secured for being exchanged in case of having a failure.

At the initial state of the RAID 0, reading is conducted on all the sectors of the user useable region AR1 to check whether or not data can be read out. When there is a sector from which data cannot be read out, it is exchanged with a sector of the substitute sector region AR2. The sector to be exchanged is also checked to see whether or not data can be read out therefrom just before the exchange.

During an operation, patrols on the user useable region are conducted. When a failure sector is found during the patrol, the failure sector is exchanged with the substitute sector. Then, the failure part is reported to the OS operated on the host. The OS searches the table of the file system to judge whether or not the reported failure part is being used. If it is not being used, no action is taken. If it is being used, information regarding the broken file is reported to the user.

When found by the patrol during the operation is not a failure but a sign of having a possible-failure (a case where data cannot be read out once, but then the command can be executed after a retry), that sector is also exchanged to reduce the rate of having a failure.

### (Processing Procedures)

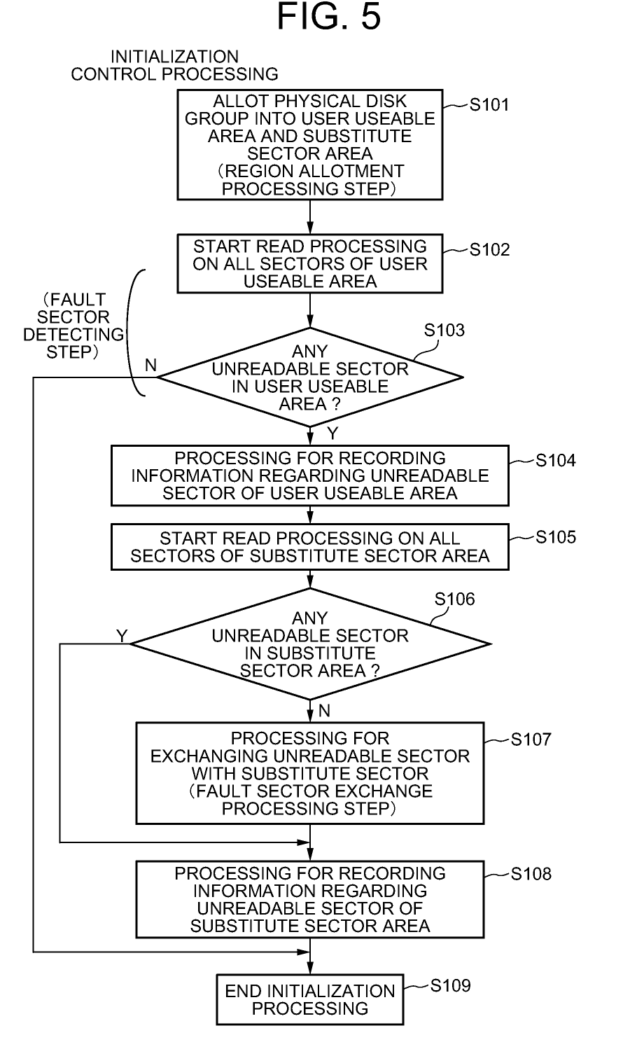

Processing of each part in the storage medium managing system having the above-described configuration can also be achieved as a method. Details of the various kinds of processing procedures as the control method of the storage medium and processing method of the higher-order device will be described by referring to FIG. 5-FIG. 7 in order from the initialization control processing, the processing related to the failure sector patrol, and the processing related to the possible-failure sector patrol.

The storage medium control method according to this exemplary embodiment is directed to manage/control the information storage device main body which is capable of communicating with the higher-order device, and is configured with a plurality of physical storage media to be capable of storing information with a non-redundant structure.

As the basic structure, this storage medium control method can include: a region allotment processing step (step S101 and the like shown in FIG. 5, for example) which performs processing for allotting each of the physical storage media to the user useable region and to the substitute sector region, respectively; a fault sector detecting step (including step S102, step S103, and the like shown in FIG. 5, for example) which executes processing for detecting presence of a fault sector from which data cannot be read out by checking the sectors of the user useable region that is allotted by the region allotment processing step at the time of initialization of the non-redundant structure; and a fault sector exchange processing step(step S108 and the like in FIG. 5, for example) which performs processing for exchanging the fault sector of the user useable region that is detected by the fault sector detecting step at the time of initialization with a normal sector of the substitute sector region of the physical storage medium.

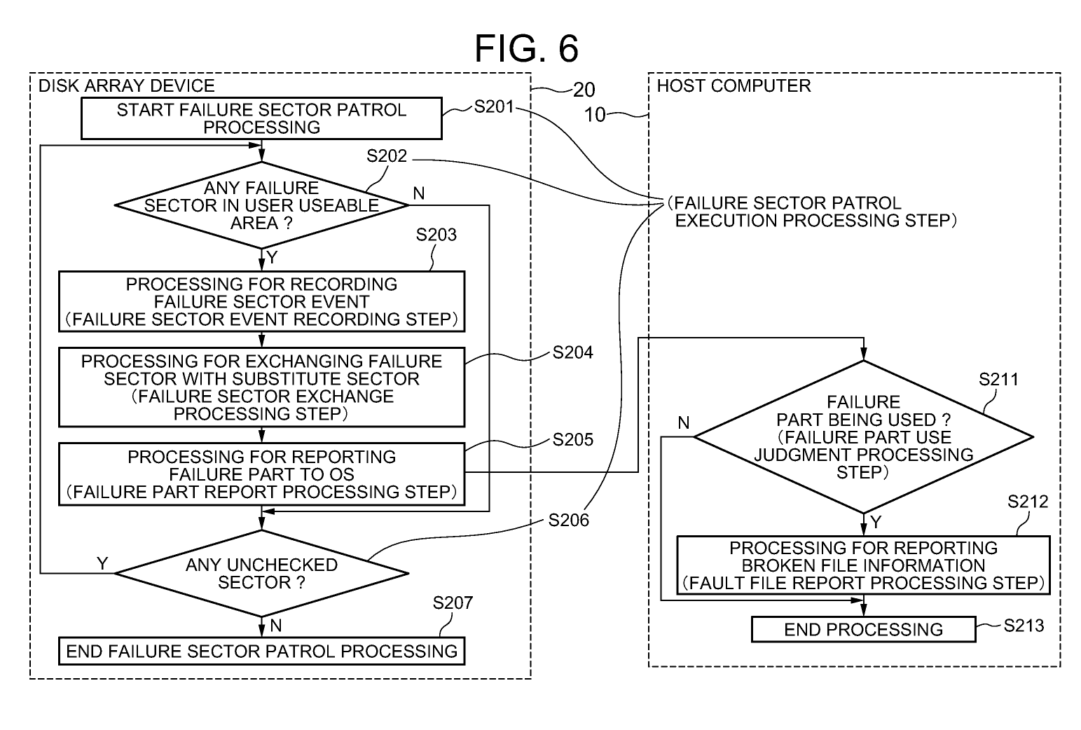

Further, the storage medium control method can also have: a failure sector patrol execution processing step (including step S208, step S202, step S206 shown in FIG. 6, for example) which executes patrol processing for checking presence of a failure sector of the physical storage media for the user useable region that is used when operating the plurality of initialized physical storage media; and a failure sector exchange processing step (step S204 and the like shown in FIG. 6, for example) which performs processing for exchanging the failure sector of the user useable region that is detected as a result of the patrol executed by the failure sector patrol execution processing step with a normal sector of the substitute sector region of the physical storage medium.

Further, the processing method of the higher-order device according to this exemplary embodiment is directed to the method executed by a higher-order device capable of communicating with the storage medium control device which is configured with a plurality of physical storage media and manages/controls the information storage device main body that is capable of storing information with a non-redundant structure.

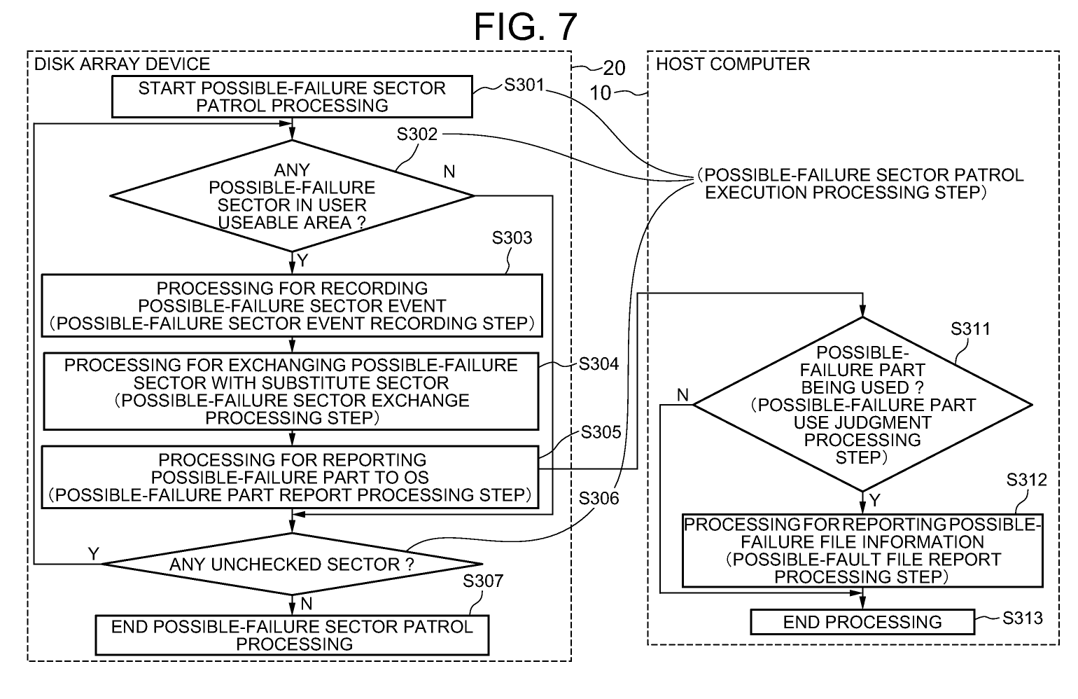

As the basic structure, the higher-order device processing method can include: a failure part use judgment processing device (step S211 and the like show in FIG. 6, for example) which performs processing for patrolling presence of a failure sector of the user useable region out of the user useable region and the substitute sector region respectively allotted to each of the physical storage media by the storage medium control device, and judging whether or not the failure part of the failure sector reported by the storage medium control device is being used; and a fault file report processing step (step S212 and the like shown in FIG. 6, for example) which, when the failure part of the failure sector is judged by the failure part use judgment processing step as being used, performs processing for reporting the user that the file corresponding to the failure sector is a fault file (broken file) Further, this higher-order device processing method can include: a possible-failure part use judgment processing step (step S311 and the like shown in FIG. 7, for example) which performs processing for judging whether or not the possible-failure part of the possible-failure sector reported from the storage medium control device as showing a sign of having a failure is being used; and a possible-fault file report processing step (step S312 and the like shown in FIG. 7, for example) which, when the possible-failure part is judged by the possible-failure part use judgment processing step as being used, performs processing for reporting the user that the file corresponding to the possible-failure sector is a possible-fault file that has a possibility of becoming broken.

### (Initialization Control Processing)

Here, the initialization control processing will be described by referring to FIG. 5. FIG. 5 is a flowchart showing an example of the initialization control processing among the processing procedures executed in the storage medium managing system according to the first exemplary embodiment of the present invention.

As shown in FIG. 5, first, the computer (or processor) provided to the controller performs processing for allotting the physical disk group into the user useable area (the user useable region) and the substitute sector are (the substitute sector region) (step S101: region allotment processing step).

Then, the computer (or the processor) starts execution of read processing on all the sectors of the user useable area (or user useable region or a first region) (step S102: first region reading execution start processing step).

Subsequently, the computer (or the processor) performs processing for judging whether or not there is an unreadable sector (fault sector) in the user useable area (the user useable region or the first region) (step S103: first region fault sector judgment processing step).

When the computer (or the processor) judges in the judgment processing of step S103 that there is no unreadable sector in the user useable area, the initialization control processing is ended.

In the meantime, when the computer (or the processor) judges in the judgment processing of step S103 that there is an unreadable sector in the user useable area, the processing for recording information of the unreadable sector of the user useable area is performed (step S104: first region fault sector information recording processing step).

Then, the computer (or the processor) starts execution of read processing on all the sectors of the alternate sector area (or alternate sector region or a second region) (step S105: second region reading execution start processing step).

Subsequently, the computer (or the processor) performs processing for judging whether or not there is an unreadable sector (fault sector) in the alternate sector area (step S106: second region fault sector judgment processing step).

When the computer (or the processor) judges in the judgment processing of step S106 that there is no unreadable sector in the substitute sector area, processing for exchanging the unreadable sector (fault sector) of the user useable area with a substitute sector (normal sector) of the substitute sector area is performed (step S107: initialization-state substitute sector exchange processing step).

In the meantime, when the computer (or the processor) judges in the judgment processing of step S106 that there is an unreadable sector in the substitute sector area, the processing for recording information of the unreadable sector of the substitute sector area is performed (step S108: second region fault sector information recording processing step).

With the above, the initialization control processing performed at the time of configuring the RAID 0 is completed.

(Processing related to Failure Sector Patrol)

Next, processing related to the failure sector patrol will be described by referring to FIG. 6. FIG. 6 is a flowchart showing an example of the processing related to the failure sector patrol among the processing procedures executed in the storage medium managing system according to the first exemplary embodiment of the invention.

First, during the operation of the disk array device, the computer (the processor) provided to the controller performs processing for starting execution of the failure sector patrol for the user useable area of the physical disk (step S201: failure sector patrol execution processing step).

Then, the computer (or the processor) performs processing for judging whether or not there is a failure sector in the user useable area (step S202: failure sector judgment processing step).

When the computer (or the processor) judges in the judgment processing of step S202 that there is no failure sector, the procedure is proceeded to step S206.

In the meantime, when the computer (or the processor) judges in the judgment processing of step S202 that there is a failure sector, processing for recording the failure sector event to the failure sector event information storage part 33a is performed (step S203: failure sector event recording step).

Subsequently, the computer (or the processor) performs processing for exchanging the failure sector with the substitute sector (normal sector) (step S204: failure sector exchanging processing step).

Then, the computer (or the processor) provided to the controller performs processing for reporting the failure part to the OS 12 of the host computer 10 (step S205: failure part report processing step).

Further, the computer (or the processor) performs processing for judging whether or not there is an unchecked sector (step S206: first unchecked sector judgment processing step).

When the computer (or the processor) judges in the judgment processing of step S206 that there is an unchecked sector, the procedure is returned to step S202 to repeat step S202-step S206.

In the meantime, when the computer (or the processor) judges in the judgment processing of step S206 that all the sectors have been checked, the failure sector patrol processing is ended (step S207).

Further, when the host computer 10 receives the report of the failure part of the failure sector from the disk array device 20 after the processing of step S205, the OS 12 of the host computer 10 performs processing for judging whether or not the failure sector is being used (step S211: failure part use judgment processing step).

When the OS 12 of the host computer 10 judges in the judgment processing of step S211 that the failure sector is not being used, the processing is ended (step S213).

In the meantime, when the OS 12 of the host computer 10 judges in the judgment processing of step S211 that the failure sector is being used, there is performed processing for reporting the user about the information regarding the broken file (fault file) that corresponds to the failure sector (step S212: fault file report processing step).

With this, the processing related to the failure sector patrol is completed.

### (Processing Related to Possible-Failure Sector Patrol)

Next, processing related to the possible-failure sector patrol will be described by referring to FIG. 7. FIG. 7 is a flowchart showing an example of the processing related to the possible-failure sector patrol among the processing procedures executed in the storage medium managing system according to the first exemplary embodiment of the invention.

First, during the operation of the disk array device, the computer (the processor) provided to the controller performs processing for starting execution of the possible-failure sector patrol for the user useable area of the physical disk (step S301: possible-failure sector patrol execution processing step).

Then, the computer (or the processor) performs processing for judging whether or not there is a possible-failure sector in the user useable area (step S302: possible-failure sector judgment processing step).

When the computer (or the processor) judges in the judgment processing of step S302 that there is no possible-failure sector, the procedure is proceeded to step S306.

In the meantime, when the computer (or the processor) judges in the judgment processing of step S302 that there is a possible-failure sector, processing for recording the failure sector event to a possible-failure sector event information storage part 33b is performed (step S303: possible-failure sector event recording step).

Subsequently, the computer (or the processor) performs processing for exchanging the possible-failure sector with the substitute sector (normal sector) (step S304: possible-failure sector exchanging processing step).

Then, the computer (or the processor) provided to the controller performs processing for reporting the possible-failure part to the OS 12 of the host computer 10 (step S305: possible-failure part report processing step).

Further, the computer (or the processor) performs processing for judging whether or not there is an unchecked sector (step S306: second unchecked sector judgment processing step).

When the computer (or the processor) judges in the judgment processing of step S306 that there is an unchecked sector, the procedure is returned to step S302 to repeat step S302-step S306.

In the meantime, when the computer (or the processor) judges in the judgment processing of step S306 that all the sectors have been checked, the possible-failure sector patrol processing is ended (step S307).

Further, when the host computer 10 receives the report of the possible-failure part of the possible-failure sector from the disk array device 20 after the processing of step S305, the OS 12 of the host computer 10 performs processing for judging whether or not the possible-failure part of the possible-failure sector is being used (step S311: possible-failure part use judgment processing step).

When the OS 12 of the host computer 10 judges in the judgment processing of step S311 that the possible-failure sector is not being used, the processing is ended (step S313).

In the meantime, when the OS 12 of the host computer 10 judges in the judgment processing of step S311 that the possible-failure sector is being used, there is performed processing for reporting the user about the information regarding the broken file (fault file) that corresponds to the possible-failure sector (step S312: possible-fault file report processing step).

With this, the processing related to the possible-failure sector patrol is completed.

As described above, with this exemplary embodiment, the disk array device that provides the function of the RAID 0 checks the fault sector, checks a sign phenomenon which indicates a possible fault, judges whether or not the target sector is being used, and exchanges the target sector with a normal sector. This makes it possible to improve the reliability of the RAID 0.

In case there is a failure sector, a substitute sector region is prepared in a region other than the region that is actually used from the OS. All the sectors are checked in the initialization processing performed at the time of forming the RAID 0. When there is a failure sector, it is exchanged with the substitute sector.

Further, during the operation, patrols are conducted to check if there is any failure sector. When a failure sector is found during the patrols, it is exchanged with the substitute sector.

Further, the disk array device reports the failure part to the OS of the host computer. The OS of the host computer searches the managing table of the file system to judge whether or not the reported sector is being used. If it is being used, the OS reports the name of the file having the failure sector, the failure part, and the like to the user. According to the reported contents, the user selects whether to recover or to discard the file.

Furthermore, in addition to the failure sectors, sign phenomena indicating possible failure sectors are also checked in the checking performed at the initialization processing and in the patrol. The sector having the sign phenomenon can be exchanged for precaution.

Note here that step S101 of this exemplary embodiment can configure the “region allotment processing step”. Further, step S102 and step S103 of this exemplary embodiment can configure the “fault sector detecting step”. Furthermore, step S107 of this exemplary embodiment can configure the “fault sector exchange processing step”.

Moreover, step S201, step S202, and step S206 of this exemplary embodiment can configure the “failure sector patrol execution step”. Further, step S203 of this exemplary embodiment can configure the “failure sector event recording step”. Furthermore, step S205 of this exemplary embodiment can configure the “failure part report processing step”. Moreover, step S204 of this exemplary embodiment can configure the “failure sector exchange processing step”.

Further, step S301, step S302, and step S306 of this exemplary embodiment can configure the “possible-failure sector patrol execution step”. Furthermore, step S303 of this exemplary embodiment can configure the “possible-failure sector event recording step”. Moreover, step S305 of this exemplary embodiment can configure the “possible-failure part report processing step”. Further, step S304 of this exemplary embodiment can configure the “possible-failure sector exchange processing step”.

Furthermore, step S211 of this exemplary embodiment can configure the “failure part use judgment processing step”. Moreover, step S212 of this exemplary embodiment can configure the “fault file report processing step”. Further, step S311 of this exemplary embodiment can configure the “possible-failure part use judgment processing step”. Furthermore, step S312 of this exemplary embodiment can configure the “possible fault file report processing step”.

The exemplary embodiment structured in the manner described above works as follows. That is: the region allotment processing device forms the user useable region and the substitute sector region at a stage of performing the initialization processing for forming the non-redundant information storage device; the fault sector detecting device checks sectors of the user useable region to detect presence of a fault sector from which information cannot be read out; and the fault sector exchange processing device performs processing for exchanging the fault sector of the user useable region detected by the fault sector exchange processing device with a normal sector of the substitute sector region. Therefore, the sector that is known to be broken before being used by the user can be eliminated in advance, so that it is possible to improve the reliability in terms of saving data.

That is, scanning performed on all the regions at the time of forming the RAID 0 and patrols conducted during the operation can increase the probability of being able to eliminate the sector that is broken before being used by the user.

Further, the patrols are conducted during the operation to check if there is any failure sector. When a failure sector is found during the operation, it can be exchanged with the substitute sector. Thus, it is possible to recover from the failure promptly.

Furthermore, the storage device works in cooperation with the OS of the host computer to judge whether or not the failure sector as the exchange target is being used. Therefore, if the failure sector is not being used, it is possible to perform recovering processing by a sector unit.

Moreover, with the related technique, the user cannot recognize that the sector is broken until the user actually attempts to perform readout processing. However, this exemplary embodiment allows the user to take measures for the failure flexibly through reporting the failure part to the user if the failure sector is being used.

Furthermore, the occurrence rate of the failure can be decreased by also exchanging the sector that has a sign phenomenon indicating a possible-failure.

That is, with the related technique, the user cannot take any precautionary measures for the failure. For example, a sign phenomenon may occur in the disk array before a sector breaks down. This is a case where the data cannot be read with a first access, but then a command can be executed after a retry. Such sign phenomenon is not so important in a redundant environment. However, when a sector breaks down, the information in that sector has to be discarded. In such case, it is possible with the exemplary embodiment to exchange the sector at the point where the sign phenomenon is detected. This makes it possible to decrease the probability of having an actual data loss.

Each block within the processor of the controller (RAID controller) in the block diagram shown in FIG. 2 and each block in the block diagram shown in FIG. 4 are software module structures that are functionalized by programs when the computer executes various programs stored in proper memories.

That is, even though the physical structures are a single or a plurality of CPU(s) (or a single or a plurality of CPU(s) and a single or a plurality of memory(s)) or the like, the software structures by each part (circuits, devices) are a plurality of functions implemented by the CPU with controls of the programs, which are expressed as feature elements of each of the plurality of parts (devices).

When the dynamic state (each procedure configuring the program is being executed) where the CPU is executed by the program is expressed functionally, it can be said that each part (device) is built within the CPU.

In a static state where the program is not being executed, the entire programs (or each program part included in the structure of each device) for achieving the structures of each device are stored in a storage area of the memory or the like.

Explanations of each part (device) provided above can be taken as the explanations of the computer that is functionalized by the programs together with the functions of the programs, or can be taken as a device that is configured with a plurality of electronic circuit blocks functionalized permanently by proper hardware. Therefore, those functional blocks can be achieved in various forms, e.g., only with hardware, only with software, or a combination of both, and it is not to be limited to any one of those forms.

The present invention structured in the manner described above works as follows. That is: a region allotment processing device forms the user useable region and the substitute sector region at a stage of performing the initialization processing for forming the information storage device of a non-redundant structure; a fault sector detecting device checks sectors of the user useable region to detect presence of a fault sector from which information cannot be read out; and a fault sector exchange processing device performs processing for exchanging the fault sector of the user useable region detected by the fault sector exchange processing device with a normal sector of the substitute sector region. Thus, the sector that is known to be broken before being used by the user can be eliminated in advance, so that the reliability in saving data can be improved. This makes it possible to provide an excellent storage medium control device and the like, which cannot be achieved with the related techniques.

### Second Exemplary Embodiment

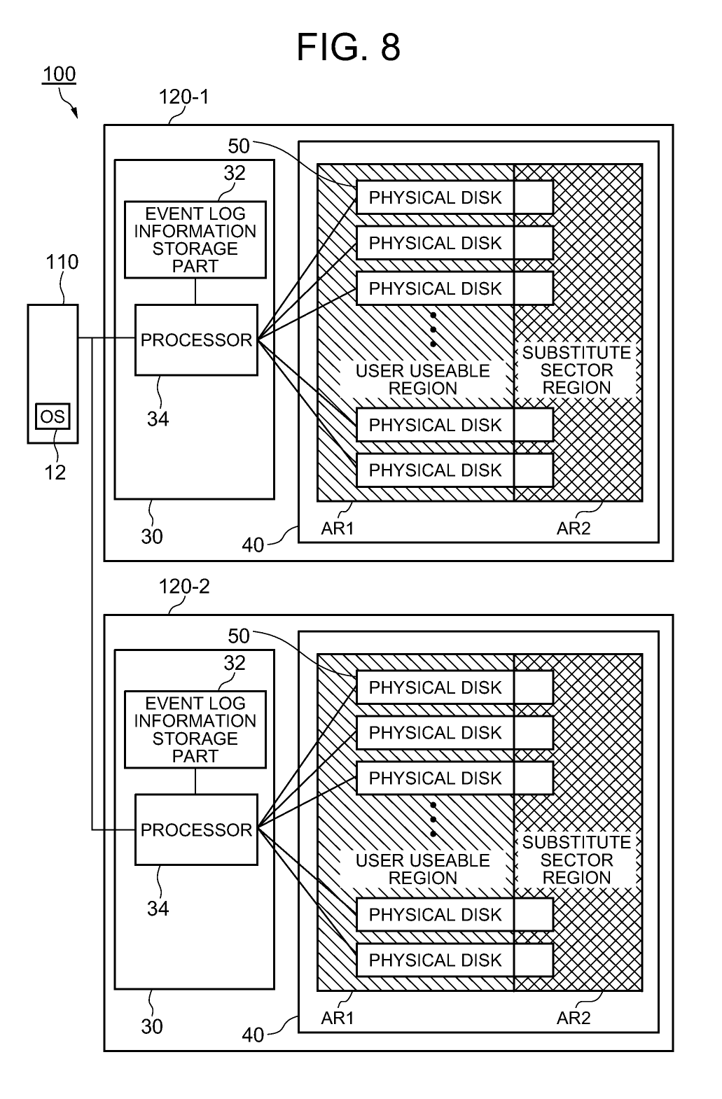

Next, a second exemplary embodiment of the invention will be described by referring to FIG. 8. Hereinafter, explanations regarding structures and the processing orders which are substantially the same as those of the first exemplary embodiment are omitted, and only the different points are described. FIG. 8 is a block diagram showing an example of the storage medium managing system including the storage medium control device according to the second exemplary embodiment of the invention.

As an example of the structure of a storage medium managing system 100, as shown in FIG. 8, disk arrays 120-1 and 120-2 having the same structure as that of the first exemplary embodiment may be formed for a host computer 110. Further, “RAID 0+1” may be formed by making use of that structure.

Other structures, steps, functions, and operational effects are the same as those of the first exemplary embodiment described above. Further, the operational contents of each step and feature elements of each part described above may be put into programs to be executed by the computer.

### (Other Various Modification Examples)

While the device and the method according to the present invention have been described by referring to some of the specific exemplary embodiments, various modifications can be applied to the exemplary embodiments depicted in the contents of the Application of the present invention without departing from the technical spirit and the scope of the present invention.

For example, the controller in each of the exemplary embodiment described above is described as a controller that manages/controls the disks only with the RAID 0. However, the controller may be such a type that has a managing function of other various kinds of RAIDs in addition to having the managing function of the RAID 0.

Further, not only the RAID 0 but also any kinds of RAIDs that may be developed or proposed in the future may be employed, as long as it is an information storage device which at least includes a non-redundant structure (does not include a redundant structure).

Furthermore, the number, the positions, the shapes, and the like of the above-described structural members are not limited to those of the exemplary embodiments, but may be set to the preferable number, positions, shapes, and the like for embodying the present invention. That is, while the exemplary embodiments have been described by referring to the case of having a single substitute sector region, the present invention is not limited to such case. It is also possible to allot a first substitute sector region for the failure sector that is exchanged after the patrol for checking a failure, a second substitute sector region for the possible-failure sector that is exchanged after the patrol for checking a possible-failure, and a third substitute sector region for the fault sector that is checked and exchanged at the time of initialization processing.

Further, as the higher-order device, not only a single host computer but also a computer system configured with a plurality of computers may be employed.

Furthermore, it is also possible to provide a maintenance terminal for changing and displaying the setting of the disk array device 20, and to form each part so as to be able to execute the various functions (functions of the higher-order device, for example) of the present invention described above from the maintenance terminal.

### (Programs)

A software program according to the present invention for achieving the functions of the above-described exemplary embodiments includes a part of or a whole part of the programs corresponding to each processing part (processing device), functions, and the like shown in various block diagrams of each of the above-described exemplary embodiments, the programs corresponding to the processing procedures, processing devices, functions, and the like shown in flowcharts of the drawings, and the method (steps) depicted generally through the current Specification, the processing and the data described herein.

Specifically, the processing control program of the present invention is directed to the storage medium control program that can be executed by a computer provided to the storage medium control device which is capable of communicating with a higher-order device and capable of managing/controlling the information storage device main body that is configured with a plurality of physical storage media to be capable of storing information with a non-redundant structure.

The storage medium control program is capable of allowing the computer to execute: a region allotment processing function (function executed by the structure shown with reference numeral 35b of FIG. 2, for example) which performs processing for allotting each of the physical storage media to the user useable region and the substitute sector region, respectively; a fault sector detecting function (function executed by the structure shown with reference numeral 35c of FIG. 2, for example) which performs processing for checking sectors of the user useable region allotted by the region allotment processing function in the initialization processing of the non-redundant structure to detect presence of a fault sector from which information cannot be read out; and a fault sector exchange processing function (function executed by the structure shown with reference numeral 35d of FIG. 2, for example)which performs processing for exchanging the fault sector of the user useable region detected by the fault sector detecting function in the initialization processing with a normal sector of the substitute sector region of the physical storage medium.

Further, the storage medium control program can also allow the computer to execute: a failure sector patrol execution processing function (function executed by the structure shown with reference numeral 36a of FIG. 2, for example) which executes patrol processing for checking presence of a failure sector of the physical storage media for the user useable region that is used when operating the plurality of initialized physical storage media; and a failure sector exchange processing function (function executed by the structure shown with reference numeral 36d of FIG. 2, for example) which performs processing for exchanging the failure sector of the user useable region that is detected as a result of the patrol executed by the failure sector patrol execution processing function with a normal sector of the substitute sector region of the physical storage medium.

Further, the storage medium control program can allow the computer to execute a failure part report processing function (function executed by the structure shown with reference numeral 36c of FIG. 2, for example) which performs processing for reporting the failure part of the failure sector to the higher-order device.

Furthermore, the storage medium control program can allow the computer to execute a failure sector event recording function (function executed by the structure shown with reference numeral 36b of FIG. 2, for example) which performs processing for recording the event log of the failure part of the failure sector to a specific storage region.

Moreover, the storage medium control program can allow the computer to execute a possible-failure sector patrol execution processing function (function executed by the structure shown with reference numeral 37a of FIG. 2, for example) which conducts a patrol for checking presence of a possible-failure sector showing a sign of having a possible-failure in the physical storage medium.

Further, the storage medium control program can allow the computer to execute a possible-failure sector exchange processing function (function executed by the structure shown with reference numeral 37e of FIG. 2, for example) which performs processing for exchanging the possible-failure sector that is detected as a result of the patrol executed by the possible-failure sector patrol execution processing function with a normal sector of the substitute sector region of the physical storage medium.

Furthermore, the storage medium control program can allow the computer to execute a possible-failure part report processing function (function executed by the structure shown with reference numeral 37d of FIG. 2, for example) which performs processing for reporting the possible-failure part of the possible-failure sector to the higher-order device.

Furthermore, the storage medium control program can allow the computer to execute a possible-failure sector event recording function (function executed by the structure shown with reference numeral 37b of FIG. 2, for example) which performs processing for recording the event log of the possible-failure part of the possible-failure sector to a specific storage region.

In the meantime, the managing program of the present invention is directed to a managing program that can be executed by a computer provided to the higher-order device that is capable of communicating with the storage medium control device which manages/controls the information storage medium main body that is configured with a plurality of physical storage media to be capable of storing information with a non-redundant structure.

This managing program can allow the computer to execute: a failure part use judgment processing function (function executed by the structure shown with reference numeral 14a of FIG. 4, for example) which performs processing for patrolling presence of a failure sector of the user useable region out of the user useable region and the substitute sector region respectively allotted to each of the physical storage media by the storage medium control device, and judging whether or not the failure part of the failure sector reported by the storage medium control device is being used; and a fault file report processing function (function executed by the structure shown with reference numeral 14b of FIG. 4, for example) which, when the failure part is judged by the failure part use judgment processing part 14a as being used, performs processing for reporting the user that the file corresponding to the failure sector is a broken fault file.

Further, the managing program can allow the computer to execute: a possible-failure part use judgment processing function (function executed by the structure shown with reference numeral 14c of FIG. 4, for example) which performs processing for judging whether or not the possible-failure part of the possible-failure sector reported from the storage medium control device as showing a sign of having a failure is being used; and a possible-fault file report processing function (function executed by the structure shown with reference numeral 14d of FIG. 4, for example) which, when the possible-failure part is judged by the possible-failure part use judgment processing function as being used, performs processing for reporting the user that the file corresponding to the possible-failure sector is a possible-fault file that has a possibility of being broken.

Further, there is no limit set in regards to the form of the programs, such as programs executed by object codes, interpreters, script data supplied to OS, etc. The programs can be loaded with a high-level procedure type or object directional programming language, or an assembly or a machine language as necessary. In any case, the languages may be a compiler type or an interpreter type. The programs also include those types in which each of the above-described programs is loaded to application soft that can be operated in a regular personal computer, an information terminal, and the like.

As a way to supply the control program, it is possible to provide the program from an external device via a telecommunication line (wired or radio) that is connected to be capable of communicating with the computer via the telecommunication line.

With the control program of the present invention, the device according to the present invention described above can be executed relatively easily by loading the control program to the computer (CPU) from a recording medium such as a ROM to which the control program is stored and having it executed, or by downloading the control program to the computer via a communication device and having it executed. When the present invention is embodied as the software of the device, there naturally is a recording medium on which the software is recorded to be used.

Further, there is no difference at all regarding the products whether it is a primary duplicate or a secondary duplicate. When the program is supplied by using the communication line, the present invention is utilized by having the communication line as a transmission medium. Further, this can be specified as the invention relate to the program. Furthermore, dependent claims regarding the device may be applied as dependent claims regarding the method and the program to correspond to the dependent claims of the device.

### (Information Recording Medium)

The above-described programs (including the storage medium control program and the managing program) may be recorded on an information recording medium. An application program including the above-described programs is stored in the information recording medium. It is possible with a computer to read out the application program from the information recording medium, and install it to a hard disk. Thereby, the above-described program can be provided by being recorded to the information recording medium, such as a magnetic recording medium, an optical recording medium, or a ROM. The use of an information recording medium having such programs recorded therein in the computer can provide a preferable information processing device.

As the information recording medium for supplying the program, semiconductor memories and integrated circuits such as ROMs, RAMs, flash memories, SRAMs, or USB memories and memory cards including those, optical disks, magneto-optical disks, magnetic recording mediums, and the like may be used. Furthermore, the program may be recorded on portable media such as flexible disks, CD-ROMs, CD-Rs, CD-RWs, FDs, DVDROMs, HDDVDs (HDDVD-R-SLs (single layer), HDDVD-R-DLs (double layer), HDDVD-RW-SLs, HDDVD-RW-DLs, HDDVD-RAM-SLs), DVD+R-SLs, DVD±R-DLs, DVD±RW-SLs, DVD±RW-DLs, DVD-RAMs, Blu-Ray Disks (registered trademark) (BD-R-SLs, BD-R-DLs, BD-RE-SLs, BD-RE-DLs), MOs, ZIPs, magnetic cards, magnetic tapes, SD cards, memory sticks, nonvolatile memory cards, IC cards, or a storage device such as hard disks that are built-in to computer systems.

Further, the “information recording medium” also includes a form which kinetically holds the program for a short period of time (transmission medium or carrier wave), e.g., a communication line when transmitting the program via a communication circuit lines such as networks of the Internet, a telephone line, etc., and also includes a form which holds the program for a specific period of time, e.g., a nonvolatile memory provided inside the computer system to be a server or a client in the above case.

Further, even in cases where a part of or the whole part of the processing is executed by an OS operated on a computer or RTOS and the like on a terminal (portable telephone, for example), the same functions and the effects as those described above can be achieved.

Furthermore, it is also possible to distribute encrypted programs stored in a recording medium such as a CD-ROM to users, let the user who has cleared a prescribed condition download key information for decrypting the program from its homepage via the Internet for allowing the user to execute the encrypted program by using the key information to install it to the computer. In that case, the structure of the present invention may include each of the feature elements (various devices, steps, and data) of the programs and an encrypting device for encrypting the programs (various devices, steps, and data).

An example of the higher-order device and the information processing device to which the above-described programs are loaded is not limited to a personal computer, for example. There are also various kinds of servers, EWS (engineering work stations), medium-sized computers, main frames, and the like. In addition to those examples, the present invention may be structured to be utilized from portable information terminals, various mobile terminals, PDAs, portable telephones, wearable information terminals, house appliances to which various kinds of communicating functions are loaded, game machines having a network function, and the like. The scope of the present invention can also include those that are modified as applications to be displayed on those terminals.

Furthermore, the program may be used to achieve a part of the above-described functions, or may be used to achieve the above-described functions by being combined with a program that is already being recorded to the computer system, i.e., may be a differential file (differential program).

Further, the steps shown in the flowcharts of the current Specification include not only the processing executed in a time series manner according to the described procedures, but also the processing that may be executed in parallel or individually. Further, in the actual implementation, the order of executing the program procedures (steps) can be changed. Furthermore, at the time of implementation, it is possible to mount, eliminate, add, or reallocate the specific procedures (steps) described in the current Specification as combined procedures (steps) as necessary.

Moreover, the functions of the program, e.g., each device, each function, and the procedures of each step of the device may be achieved by exclusive hardware (for example, exclusive semiconductor circuit). A part of the whole functions of the program may be processed by the hardware, and the other functions of the whole functions may be processed by the use of software. In the case of using the exclusive hardware, each part maybe formed with an integrated circuit such as LSI. These may be formed on a single chip individually, or may be formed on a single chip including a part of or a whole part of the integrated circuits. Further, LSI may include other functional blocks such as various circuits. The way of integration is not limited only to LSI. An exclusive circuit or a general-purpose processor may also be employed. Further, when there is a technique related to integration of circuits developed in replacement for LSI due to advancement in the semiconductor technology or another technique derived therefrom, such technique may naturally be used for integrating the functional blocks.

The network and communications between the higher-order device and the information storage device may include radio communication, wired communication, and communication that is a mixture of the radio communication and the wired communication (i.e., a case where radio communication is performed in some sections and wired communication is performed in the other sections). Further, communication from a certain device to another device may be performed by radio communication and communication from another device to the certain device may be performed by radio communication.

This communication includes a communication net. As a network configuring the communication net, any hardware structure such as a portable telephone line network (including abase station and a switching system), a public telephone line network, an IP telephone network, an ISDN line network, various kinds of line networks similar to those, the Internet (that is, communication modes using TCP/IP protocols), the intranet, LAN (including Ethernet (registered trademark) and gigabit Ethernet), WAN, an optical fiber communication network, an power-line communication network, various dedicated line networks compatible with broadband or the like may be used. Furthermore, in addition to the network using TCP/IP protocols, the network may use any kinds of communication protocols, e.g., networks using various kinds of protocols, virtual networks built on software, and networks similar to those. Moreover, the network is not limited to a wired network but may also be a radio (including satellite communication, various high-frequency communication devices, and the like) network (e.g., single carrier communication system such as a personal handy phone system or a portable telephone, spectrum spread communication system such as W-CDMA and radio LAN conforming to IEEE 802.11b, multi-carrier system such as IEEE 802.11a or Hiper LAN/2, etc). A combination of those may also be used. A system connected to another network may be used as well. Further, the network may be in any forms such as point-to-point, point-to-multipoints, multipoints-to-multipoints, and the like.

Furthermore, regarding the communication structure between the higher-order device and the information storage device, the type of the interface formed in one of or both of the devices may be a parallel interface, a USB interface, IEEE 1394, a network such as LAN or WAN, others that are similar to those, and any kinds of interfaces that may be developed in the future.

Moreover, the technique which provides the substitute sector region when building the non-redundant structure such as the RAID 0 and checks each sector to exchange a fault sector with a normal sector of the substitute sector region as well as the technique which checks each sector and exchanges the fault sector with a normal sector during the operation is not necessarily limited to substantial devices. It is to be easily understood that those can function as the methods. Inversely, the present invention regarding the method is not necessarily limited to the substantial devices, but may be effective as the method thereof. In that case, the storage medium control device, the information storage device, the storage medium managing system, and the like can also be included as examples for achieving the method.

Such device (storage medium control device: controller) may be used alone or used by being mounted to a certain apparatus (information storage device: disk array device, for example). The spirit of the present invention is not intended to be limited only to such case, but to include other various kinds of modes. Therefore, it is possible to be achieved as software or hardware as appropriate. When it is built as software as an example of embodying the spirit of the present invention, there naturally is a recording medium on which the software is stored to be used.

Further, a part thereof may be achieved by the software and another part may be achieved by the hardware. It may also be in a form where a part is stored on a recording medium to be loaded properly as necessary. When the present invention is achieved with the software, it is possible to be structured to use hardware and an operating system, or may be achieved separately from those.

Furthermore, the scope of the present invention is not limited to the examples shown in the drawings.

Moreover, each of the exemplary embodiments includes various stages, and various kinds of inventions can be derived therefrom by properly combining a plurality of feature elements disclosed therein. That is, the present invention includes combinations of each of the above-described exemplary embodiments or combinations of any of the exemplary embodiments and any of the modifications examples thereof. In that case, even though it is not specifically mentioned in the exemplary embodiments, the operational effects that are obvious from each structure disclosed in each of the exemplary embodiments and the modification examples thereof can naturally be included as the operational effects of the exemplary embodiments. Inversely, the structures that can provide all the operational effects depicted in the exemplary embodiments are not necessarily the essential feature elements of the substantial feature parts of the present invention. Furthermore, the present invention can include structures of other exemplary embodiments in which some of the feature elements are omitted from the entire feature elements of the above-described exemplary embodiments, as well as the technical scope of the structures based thereupon.

The descriptions regarding each of the exemplary embodiments including the modification examples thereof are presented merely as examples of various embodiments of the present invention (i.e., examples of concretive cases for embodying the present invention) for implementing easy understanding of the present invention. It is to be understood that those exemplary embodiments and the modification examples thereof are illustrative examples, and not intended to set any limitations therewith. The present invention can be modified and/or changed as appropriate. Further, the present invention can be embodied in various forms based upon the technical spirit or the main features thereof, and the technical scope of the present invention is not to be limited by the exemplary embodiments and the modification examples.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

Therefore, each element disclosed above is to include all the possible design changes and the equivalents that fall within the technical scope of the present invention.

The present invention can be applied to disk array devices in general.

What is claimed is:

1. A storage medium control device capable of communicating with a higher-order device and capable of managing/controlling an information storage device main body which is configured with a plurality of physical storage media to be able to store information with a non-redundant structure, the storage medium control device comprising:
a region allotment processing device which performs processing for allotting each of the physical recording media to a user useable region and to a substitute sector region, respectively;
a fault sector detecting device which performs processing for checking sectors of the user useable region allotted by the region allotment processing device in initialization processing of the non-redundant structure to detect presence of a fault sector from which information cannot be read out; and
a fault sector exchange processing device which performs processing for exchanging the fault sector of the user useable region detected by the fault sector detecting device in the initialization processing with a normal sector of the substitute sector region of the physical storage media.

2. The storage medium control device as claimed in claim 1, further comprising:
a failure sector patrol execution processing device which executes patrol processing for checking presence of a failure sector of the physical storage media for the user useable region that is used when operating the plurality of initialized physical storage media; and
a failure sector exchange processing device which performs processing for exchanging the failure sector of the user useable region that is detected as a result of the patrol executed by the failure sector patrol execution processing device with a normal sector of the substitute sector region of the physical storage media.

3. The storage medium control device as claimed in claim 2, further comprising:
a failure part report processing device which performs processing for reporting a failure part of the failure sector to the higher-order device.

4. The storage medium control device as claimed in claim 3, further comprising:
a failure sector event recording device which performs processing for recording an event log of the failure part of the failure sector to a specific storage region.

5. The storage medium control device as claimed in claim 4, further comprising:
a possible-failure sector patrol execution processing device which conducts a patrol for checking presence of a possible-failure sector showing a sign of having a possible-failure in the physical storage media.

6. The storage medium control device as claimed in claim 5, further comprising:
a possible-failure sector exchange processing device which performs processing for exchanging the possible-failure sector that is detected as a result of the patrol executed by the possible-failure sector patrol execution processing device with a normal sector of the substitute sector region of the physical storage media.

7. The storage medium control device as claimed in claim 6, further comprising:
a possible-failure part report processing device which performs processing for reporting a possible-failure part of the possible-failure sector to the higher-order device.

8. The storage medium control device as claimed in claim 7, further comprising:
a possible-failure sector event recording device which performs processing for recording an event log of the possible-failure part of the possible-failure sector to a specific storage region.

9. An information storage device, comprising:
the storage medium control device formed to be communicable with the higher-order device as claimed in claim 1; and
a plurality of physical recording media that are managed/controlled by the storage medium control device.

10. A storage medium managing system, comprising:
an information storage medium device main body which is configured with a plurality of physical storage media to be capable of storing information with a non-redundant structure;
a storage medium control device for managing/controlling the information storage device main body; and
a higher-order device that is communicable with the storage medium control device, wherein
the storage medium control device includes:
a region allotment processing device which performs processing for allotting each of the physical recording media to a user useable region and to a substitute sector region, respectively;
a fault sector detecting device which performs processing for checking sectors of the user useable region allotted by the region allotment processing device in initialization processing of the non-redundant structure to detect presence of a fault sector from which information cannot be read out; and
a fault sector exchange processing device which performs processing for exchanging the fault sector of the user useable region detected by the fault sector detecting device in the initialization processing with a normal sector of the substitute sector region of the physical storage media.

11. The storage medium managing system as claimed in claim 10, wherein the storage medium control device further comprises:
a failure sector patrol execution processing device which executes patrol processing for checking presence of a failure sector of the physical storage media for the user useable region that is used when operating the plurality of initialized physical storage media;
a failure sector exchange processing device which performs processing for exchanging the failure sector of the user useable region that is detected as a result of the patrol executed by the failure sector patrol execution processing device with a normal sector of the substitute sector region of the physical storage media; and
a failure part report processing device which performs processing for reporting a failure part of the failure sector to the higher-order device.

12. The storage medium managing system as claimed in claim 11, wherein the higher-order device further comprises:
a failure part use judgment processing device which performs processing for judging whether or not the failure part of the failure sector reported by the failure part report processing device of the storage medium control device is being used; and
a fault file report processing device which, when the failure part of the failure sector is judged by the failure part use judgment processing device as being used, performs processing for reporting the user that the file corresponding to the failure sector is a broken fault file.

13. The storage medium managing system as claimed in claim 12, wherein the storage medium control device further comprises:
a possible-failure sector patrol execution processing device which executes patrol processing for checking presence of a possible-failure sector of the physical storage media showing a sign of having a failure;
a possible-failure sector exchange processing device which performs processing for exchanging the possible-failure sector that is detected as a result of the patrol executed by the possible-failure sector patrol execution processing device with a normal sector of the substitute sector region of the physical storage media; and
a possible-failure part report processing device which performs processing for reporting a possible-failure part of the possible-failure sector to the higher-order device.

14. The storage medium managing system as claimed in claim 13, wherein the higher-order device further comprises:
a possible-failure part use judgment processing device which performs processing for judging whether or not the possible-failure part of the possible-failure sector reported by the possible-failure part report processing device of the storage medium control device is being used; and
a possible-fault file report processing device which, when the possible-failure part of the possible-failure sector is judged by the possible-failure part use judgment processing device as being used, performs processing for reporting the user that the file corresponding to the possible-failure sector is a possible-fault file that is possible to become broken.

15. A storage medium control method for managing/controlling an information storage device main body which is communicable with a higher-order device and is configured with a plurality of physical storage media to be capable of storing information with a non-redundant structure, the method comprising:
allotting each of the physical storage media to a user useable region and to a substitute sector region, respectively;
detecting presence of a fault sector from which data cannot be read out by checking the sectors of the user useable region that is allotted, at a time of initialization of the non-redundant structure; and
exchanging the fault sector of the user useable region that is detected by checking the sectors of the user useable region, at the time of initialization with a normal sector of the substitute sector region of the physical storage media.

16. The storage medium control method as claimed in claim 15, further comprising:
executing patrol processing for checking presence of a failure sector of the physical storage media for the user useable region that is used when operating the plurality of initialized physical storage media; and
exchanging the failure sector of the user useable region that is detected as a result of the patrol executed by the patrol processing with a normal sector of the substitute sector region of the physical storage media.

17. The storage medium control method as claimed in claim 16, further comprising:
reporting a failure part of the failure sector to the higher-order device.

18. The storage medium control method as claimed in claim 17, further comprising:
recording an event log of the failure part of the failure sector to a specific storage region.

19. The storage medium control method as claimed in claim 18, further comprising:
conducting a patrol for checking presence of a possible-failure sector showing a sign of having a possible-failure in the physical storage media.

20. The storage medium control method as claimed in claim 19, further comprising:
exchanging the possible-failure sector that is detected as a result of the patrol for checking presence of the possible-failure sector with a normal sector of the substitute sector region of the physical storage media.

21. The storage medium control method as claimed in claim 20, further comprising:
reporting the possible-failure part of the possible-failure sector to the higher-order device.

22. The storage medium control method as claimed in claim 21, further comprising:
recording an event log of the possible-failure part of the possible-failure sector to a specific storage region.

23. A computer readable recording medium for storing a storage medium control program for allowing a computer, which is provided to a storage medium control device capable of communicating with a higher-order device and capable of managing/controlling an information storage device main body that is configured with a plurality of physical storage media to be able to store information with a non-redundant structure, to execute:
a region allotment processing function which performs processing for allotting each of the physical recording media to a user useable region and to a substitute sector region, respectively;
a fault sector detecting function which performs processing for checking sectors of the user useable region allotted by the region allotment processing function in initialization processing of the non-redundant structure to detect presence of a fault sector from which information cannot be read out; and
a fault sector exchange processing function which performs processing for exchanging the fault sector of the user useable region detected by the fault sector detecting function in the initialization processing with a normal sector of the substitute sector region of the physical storage media.

24. The computer readable recording medium for storing the storage medium control program as claimed in claim 23, which further allows the computer to execute:
a failure sector patrol execution processing function which executes patrol processing for checking presence of a failure sector of the physical storage media for the user useable region that is used when operating the plurality of initialized physical storage media; and
a failure sector exchange processing function which performs processing for exchanging the failure sector of the user useable region that is detected as a result of the patrol executed by the failure sector patrol execution processing function with a normal sector of the substitute sector region of the physical storage media.

25. The computer readable recording medium for storing the storage medium control program as claimed in claim 24, which further allows the computer to execute:
a failure part report processing function which performs processing for reporting a failure part of the failure sector to the higher-order device.

26. A storage medium control device capable of communicating with a higher-order device and capable of managing/controlling an information storage device main body which is configured with a plurality of physical storage media to be able to store information with a non-redundant structure, the storage medium control device comprising:
region allotment processing means for allotting each of the physical recording media to a user useable region and to a substitute sector region, respectively;
fault sector detecting means for checking sectors of the user useable region allotted by the region allotment processing means in initialization processing of the non-redundant structure to detect presence of a fault sector from which information cannot be read out; and
fault sector exchange processing means for exchanging the fault sector of the user useable region detected by the fault sector detecting means in the initialization processing with a normal sector of the substitute sector region of the physical storage media.

27. A storage medium managing system, comprising:
an information storage medium device main body which is configured with a plurality of physical storage media to be capable of storing information with a non-redundant structure;
storage medium control means for managing/controlling the information storage device main body; and
a higher-order device that is communicable with the storage medium control means, wherein
the storage medium control means includes:
region allotment processing means for allotting each of the physical recording media to a user useable region and to a substitute sector region, respectively;
fault sector detecting means for checking sectors of the user useable region allotted by the region allotment processing means in initialization processing of the non-redundant structure to detect presence of a fault sector from which information cannot be read out; and
fault sector exchange processing means for exchanging the fault sector of the user useable region detected by the fault sector detecting means in the initialization processing with a normal sector of the substitute sector region of the physical storage media.
